(19) United States
(12) Patent Application Publication
(10) Pub. No.: US 2020/0093154 A1
(43) Pub. Date: Mar. 26, 2020

(54) MULTIPLE SECTION FROZEN SUPPLEMENTARY BEAD

(71) Applicant: Jeremy Maynard, Lexington, KY (US)

(72) Inventor: Jeremy Maynard, Lexington, KY (US)

(21) Appl. No.: 16/138,982

(22) Filed: Sep. 22, 2018

(51) Int. Cl. A23G 9/16; A23G 9/28; F25D 3/11

(52) U.S. Cl. CPC A23G 9/166; F25D 25/04; F25D 3/11; A23G 9/281

(57) ABSTRACT

A frozen supplementary bead, including a first section including a first attribute; and a second section including a second attribute, wherein the second attribute is not the first attribute.

### FIELD OF THE INVENTION

The present invention relates to cryogenically frozen products.

### BACKGROUND OF THE INVENTION

Dippin' Dots is advertised as “the ice cream of the future.” As such, the frozen beaded ice cream has attracted millions of consumers world-wide. These “frozen beads” are produced by dripping a liquid ice cream precursor into a cryogenic fluid, such as liquid nitrogen. However, each individual bead produced is only a single flavor and a single color.

### SUMMARY OF THE INVENTION

Embodiments of the present invention relate to a frozen supplementary bead, including a first section including a first attribute; and a second section including a second attribute, wherein the second attribute is not the first attribute.

Further embodiments of the present invention relate to a dropper apparatus including a dropper including a first chamber and a second chamber separated by a dropper divider at a first end of the dropper, the first end configured to receive at least two supplementary liquids, the dropper including a second end configured to join the at least two supplementary liquids upon dripping the supplementary liquid.

Additional embodiments of the present invention relate to a method of producing a frozen supplementary bead, including dripping a first supplementary liquid and a second supplementary liquid such that the first supplementary liquid joins the second supplementary liquid in a single droplet before reaching a cryogenic fluid, wherein the droplet forms a frozen supplementary bead including a first section corresponding to the first supplementary liquid and a second section corresponding to the second supplementary liquid.

### BRIEF DESCRIPTION OF THE DRAWINGS

FIG. 1 depicts a diagram cross-sectional view of an apparatus for preparing the free-flowing, frozen supplementary product in accordance with the principles of the present invention.

FIG. 2 depicts a tray of the apparatus of FIG. 1 in accordance with the principles of the present invention.

FIG. 3 depicts a side view of the tray of FIG. 2 in accordance with the principles of the present invention.

FIG. 4 depicts a side view of an alternative tray in accordance with the principles of the present invention.

FIG. 5A depicts a dropper of the tray of FIG. 2 comprising a dropper divider for retaining multiple discrete supplementary liquids separate before dripping in accordance with the principles of the present invention.

FIG. 5B depicts the dropper of the tray of FIG. 2 comprising an alternative arrangement of dropper divider in accordance with the principles of the present invention.

FIG. 5C depicts the dropper of the tray of FIG. 2 comprising another alternative arrangement of dropper divider in accordance with the principles of the present invention.

FIG. 6A depicts the dropper of FIG. 5A comprising a dropper divider and a combined droplet comprising a first supplemental liquid section and a second supplemental liquid section in accordance with the principles of the present invention.

FIG. 6B depicts the dropper of FIG. 5B comprising a dropper divider and a combined droplet comprising a first supplemental liquid section and a second supplemental liquid section in accordance with the principles of the present invention.

FIG. 6C depicts the dropper of FIG. 5C comprising a dropper divider and a combined droplet comprising a first supplemental liquid section and a second supplemental liquid section in accordance with the principles of the present invention.

FIG. 7A depicts a view of the first end of the dropper of FIG. 5A in accordance with the principles of the present invention.

FIG. 7B depicts a view of the first end of an alternative dropper in accordance with the principles of the present invention.

FIG. 7C depicts another alternative dropper comprising a spiral dropper divider in accordance with the principles of the present invention.

FIG. 8A depicts a frozen supplementary bead comprising discrete sections in accordance with the principles of the present invention.

FIG. 8B depicts an alternate frozen supplementary bead comprising discrete sections in accordance with the principles of the present invention.

FIG. 8C depicts a frozen supplementary bead comprising swirled discrete sections in accordance with the principles of the present invention.

FIG. 9A depicts a top-down view of a tray of the apparatus of FIG. 1 in accordance with the principles of the present invention.

FIG. 9B depicts an alternative arrangement of the tray of FIG. 9A in accordance with the principles of the present invention.

FIG. 9C depicts an alternative arrangement of the tray of FIG. 9A in accordance with the principles of the present invention.

### DETAILED DESCRIPTION OF THE PREFERRED EMBODIMENTS

“About,” as used in this application, means within plus or minus one at the last reported digit. For example, about 1.00 means 1.00±0.01 unit.

“Around,” when used to describe a unit or percentage, means within plus or minus one unit or plus or minus one percentage point.

“Bead,” as used herein, means any shape formed by dripping a liquid into a cryogenic fluid. A bead may be substantially round, such as spherical, substantially spherical, oblate, oblong, pocked, bumpy, etc. (e.g. as illustrated with respect to US 2009/0077980). In some embodiments, a bead may resemble popcorn shapes when beads begin to freeze and appendages breach the initial shell before freezing is complete (e.g. as illustrated with respect to U.S. Pat. No. 6,555,154).

The beads (e.g. pellets) can have a variety of different shapes and sizes. For example, a pellet size between about 4 and 10 mm in diameter is contemplated. However, larger and smaller sized pellets may be also contemplated. As for texture, the pellets may be relatively uniform spherical beads with a relatively smooth surface. However, a rough surface texture and irregular shaped beads or pellets may be beneficial as well. Thus, pellets resembling small asteroids or rocks may be contemplated that have a nominal size of about 2 to 12 mm.

“Proximate,” when used to describe position of an element relative to one object of a set of multiple objects, conveys that the element is positioned closer to the one object than any other object of the set.

“Substantially,” as used in this application with reference to an angle, means within one degree. For example, substantially planar means within one degree counterclockwise and within one degree clockwise of planar orientation.

“Substantially,” as used in this application with reference to a shape, means within manufacturing tolerance of manufacturing the referenced shape as well as any other shape falling within the doctrine of equivalents for the referenced shape.

“Substantially similar,” as used in this application, means having at least each of the properties of the referenced structure plus the additional structure disclosed. If the additional structure conflicts, the additional structure supersedes the structure incorporated by reference.

“Free-flowing,” as used herein, is a broad term which includes the ability of the product to flow as individual beads, with little or no clumping or sticking to each other, during such pouring. There may be slight sticking after a period of storage, but a light tap on the container may unstick the beads and allow them to be free-flowing. The generally spherical shape helps contribute to the free-flowing, pourable product. It may be desired that the beaded product is in a free-flowing format so that it is readily pourable.

“Supplementary,” as used in this application, means at least one of alimentary, comestible, pharmaceutical, and/or probiotic.

“Section,” as used herein with regard to a frozen bead, means at least a portion of the bead extending from a portion of a surface of the bead to a portion of the interior of the bead. In some embodiments, each section may extend 0.5 mm or more from the portion of the surface of the bead to the interior. In additional embodiments, each section may extend 1.0 mm or more from the portion of the surface of the bead to the interior. In further embodiments, each section may extend from the corresponding portion of the surface of the bead to the center of the interior.

For the purposes of this disclosure, “and” and “or” shall be construed as conjunctively or disjunctively, whichever provides the broadest disclosure in each instance of use of “and” and “or.”

For the purposes of this disclosure, structures disclosed in singular form are not limited to a single structure, but can include multiple instances of the disclosed structure, unless specifically stated otherwise.

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

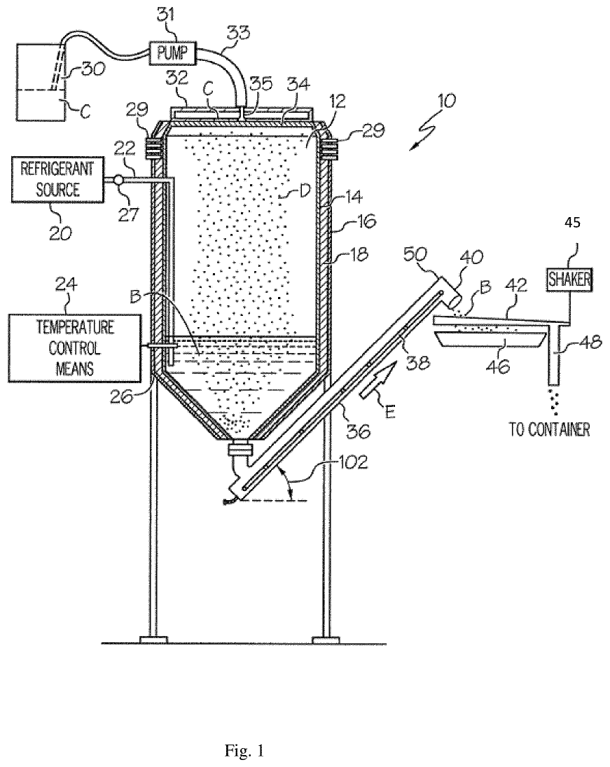

FIG. 1 depicts a diagram of a cross-sectional view of an apparatus 10 for preparing the free-flowing, frozen supplementary product in accordance with the principles of the present invention. It should be recognized that this apparatus 10 is merely being described as an example of one type of apparatus designed for this purpose. Other designs may, of course, be utilized in accordance with the present method to produce the free-flowing, frozen supplementary product.

As shown, the apparatus 10 can include a freezing chamber 12 having an inner wall 14 and outer wall 16. In some embodiments, both the walls 14 and 16 may be constructed of stainless steel to provide both strength and corrosion resistance. However, the walls 14 and 16 may comprise any material sufficient to withstand cryogenic temperatures while retaining the structural integrity of the freezing chamber 12. A thick layer of thermal insulating construction 18 may be provided between the walls 14, 16 to improve the efficiency of the freezing chamber by reducing the thermal transfer through the walls 14, 16 between the interior of the chamber 12 and the ambient environment. In some embodiments, the thermal insulating construction 18 may include an insulating material, such as fiberglass. Other embodiments include a thermal insulating construction 18 comprising a vacuum between the walls 14, 16.

The freezing chamber 12 may be chilled by the direct addition of refrigerant from a refrigerant source 20 through the delivery line 22. A number of different refrigerants can be utilized, including liquid nitrogen. Liquid nitrogen is readily available, relatively inexpensive and relatively inert to food products. It is also sufficiently cold to provide for relatively rapid freezing of the product. As such, liquid nitrogen may be utilized in the processing of free-flowing, supplementary products in accordance with the present invention.

The temperature of the freezing chamber as well as the level of liquid refrigerant may be maintained within a specified range through the utilization of a temperature control means 24 such as a thermostat as is known in the art. More specifically, the temperature control means 24 may be connected to a thermocouple 26. The thermocouple 26 may be positioned to extend into the freezing chamber 12 at a selected height between, for example, 4 to 18 inches above the bottom of the chamber to sense the temperature within the chamber. Where, for example, liquid nitrogen is utilized as the refrigerant, the thermostat may be set to maintain the temperature within the chamber 12 at a thermocouple 26 between approximately −184° C. (−300° F.) to approximately −195° C. (−320° F.). The positioning of the thermocouple 26 some 4 to 18 inches above the bottom of the chamber 12 may provide the necessary reservoir of refrigerant to quick freeze the droplets of the supplementary composition. The ultra-low temperature of the refrigerant can limit the formation of ice crystals in the product as it is frozen. Advantageously, by reducing the overall size of the ice crystals being formed, the resulting frozen product may have a richer, creamier texture and exhibit a better overall flavor.

For example, when the temperature within the chamber 12 at the thermocouple 26 rises above the set range of operation (i.e. −300° to −320° F.), this can be an indication that the level of liquid refrigerant has fallen below the thermocouple. As a result of the operation of the temperature control means 24, a valve 27 may then be opened to allow delivery of liquid nitrogen from the source 20 through the line 22 to the chamber 12. Once the liquid refrigerant level within the chamber 12 reaches and contacts the thermocouple 26, the desired level of liquid refrigerant for freezing the composition is restored and the valve 27 may be closed.

Alternative temperature or level control systems may be utilized. For example, a number of thermocouples 26 may be positioned at various heights within the chamber 12. The thermocouple 26 at the desired liquid refrigerant level to be maintained can then be selected and utilized as described above. In another alternative, a liquid nitrogen level controller such as manufactured and marketed by Minnesota Valley Engineering, Inc. under the trademark CRYO-MED (Model LL-450) may be utilized.

Vents 29 may be provided in the walls 14, 16 near the top of the freezing chamber 12. These vents 29 may serve to release rising nitrogen vapor from the chamber 12 and may prevent any build-up in pressure in the chamber or any excess lowering of temperature near the top such that the dropper system is frozen over time. This exhaust can be controlled manually by venting through an exit pipe which may be controlled by a damper. Alternatively, the exhaust gas can be collected under vacuum by the use of an exhaust fan. This cold vapor can be routed to other parts of the process where cold vapors can be utilized such as in storage spaces or with packaging machines.

The first step of a method of the present invention may be to prepare a supplementary composition for freezing. In some embodiments, the composition may be dairy based and can include such ingredients as cream, milk, butter and/or eggs. Additional ingredients could include sugar, fruit extracts or some other flavoring component, such as vanilla extract. However, embodiments include probiotic formulations, pharmaceutical formulations, non-dairy based formulations for forming frozen confectionary beads, etc.

After preparing the composition comes the step of slowly dripping the composition into the freezing chamber 12. This may be accomplished in a number of ways. For example, as shown in FIG. 1, the composition C may be pumped from a supply container 30 into a dropper system including a tray 32 positioned across the upper end of the freezing chamber 12. More specifically, the composition may be pumped by pump 31 through the tube 33 so as to be delivered through an inlet 35 in the top of the tray that closes the tray to prevent any residual dirt or dust in the air from falling into the composition. The bottom of the tray 32 can include a series of apertures 34 through which the composition drips into the freezing chamber 12. The apertures may have a diameter of between about 0.3175 cm (0.125 inches) and 0.794 cm (0.3125 inches) so as to provide the desired size droplets of composition for freezing into beads. Of course, the size of the droplets and rate of flow may be determined not only by the size of the holes, but the thickness of the composition and in some cases the thickness of the tray.

As the droplets D of composition fall downwardly in the freezing chamber, they contact cold nitrogen gas rapidly vaporizing from the pool of liquid nitrogen P at the bottom of the chamber 12. As a result of the temperature within the range of −162° C. (−260° F.) to −195° C. (−320° F.) (for liquid N₂), rapid freezing of the droplets of composition occurs. The small beads B that are produced might contain only relatively small ice crystals. The beads B may have a smooth, spherical appearance.

A conveyor belt assembly 50 for collecting the beads B may extend into the bottom of the chamber 12 at an intake end of an elongated housing 36. The conveyor belt assembly 50 may comprise a conveyor belt 38 within the housing 36. Furthermore, the conveyor belt 38 may extend from the intake end of the housing 36 to a discharge end comprising a chute 40. As shown, the conveyor belt 38 may be positioned at a conveying angle 102 ranging from approximately 55° to approximately 60° with respect to the horizontal plane. As depicted, the conveyor belt 38 may be substantially parallel to the housing 36. The horizontal plane refers to the plane that is perpendicular to the lengthwise plane of the apparatus 10. Furthermore, the horizontal plane may be parallel to the ground when the apparatus 10 is in upright position upon the ground. Embodiments of the present invention also include an angle of approximately 50° from the horizontal plan, and 45° from the horizontal plane. The conveyor belt 38 can include transport structures (not illustrated in FIG. 1) that move the beads B against gravity out of the bottom of chamber 12 through the chute 40.

As the conveyor belt 38 is rotated, the beads B may be drawn upwardly in the direction of action arrow E on the conveyor belt 38 and/or transport structures. Liquid refrigerant, however, may not necessarily be withdrawn from the freezing chamber 12 as the liquid nitrogen may drain back to the pool P.

Conveyor belt 38 may be comprised of any material that is resilient while bending under cryogenic conditions. Example materials include rubber and linked metal constructions. In embodiments having linked metal constructions. Small holes between the metal links may be used to strain the cryogenic liquid from the beads B back to chamber 12.

Once the beads B reach the top of the conveyor belt 38, they may be deposited by means of a chute 40 onto a sieve 42. The sieve 42 may be connected to a shaking apparatus 45 as is known in the art. This shaking apparatus 45 can vibrate the beads B on the sieve 42. Thus, sifting of the beads B may occur with the relatively large beads having a diameter of, for example, approximately 2 mm or larger remaining on the surface of the sieve while the smaller beads and fragmented portions of broken beads may fall through the sieve into the collecting pan 46. That material collected in the pan 46 may be melted and reprocessed by mixing back in with the composition C that is added to the tray 32 as described above.

The appropriately-sized beads (e.g. diameter of greater than 2 mm) may flow over the sieve to a discharge chute 48 where they may be deposited into a container (not shown). This container may be maintained open for substantially 1-10 minutes in order to allow any residual nitrogen refrigerant retained in or on the surface of the beads to vaporize. Then, the container may be sealed and placed in a freezer for storage.

In order to prevent the beads B from sticking together during storage and thereby maintain their free-flowing character, they can be maintained at a relatively low temperature. More specifically, if the beads B are to be stored for greater than a period of approximately 30 hours, they should be stored in the refrigerator at a temperature of at least as low as −28.9 C° (−20° F.). The beads may be stored at a temperature between −1.1° C. (−30° F.) and −40° C. (−40° F.).

Alternatively, if the beads B are to be consumed within a 30-hour period (or shorter period of 10-12 hours for certain compositions), they can be stored in the freezer at a temperature of −28.9° C. (−20° F.) or above. However, the beads B can be brought to a temperature between about −23.3° C. (−10° F.) and −28.9° C. (−20° F.), with −26.1° C. (−15° F.) providing good results. Warmer temperatures may result in the beads sticking together and the product losing its unique free-flowing property, thus reducing its consumer appeal. When served at a colder temperature, many individuals may find that the product is too cold to be fully enjoyed.

As a result of the methods described herein, product may be in the form of small particulate shapes that remain free-flowing during storage. The particulate shapes, generally referred to as “beads”, may have a generally spherical, spheroid shape but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes may have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It may be desired that the particulate or beaded product is in a free-flowing format so that it is readily pourable. Free-flowing, as used herein, is a broad term which includes the ability of the product to flow as individual particulate shapes, with little or no clumping or sticking to each other, during such pouring. There may be slight sticking after a period of storage, but a light tap on the container may unstick the particulate shapes and allow them to be free flowing. The generally spherical shape helps contribute to the free-flowing, pourable product.

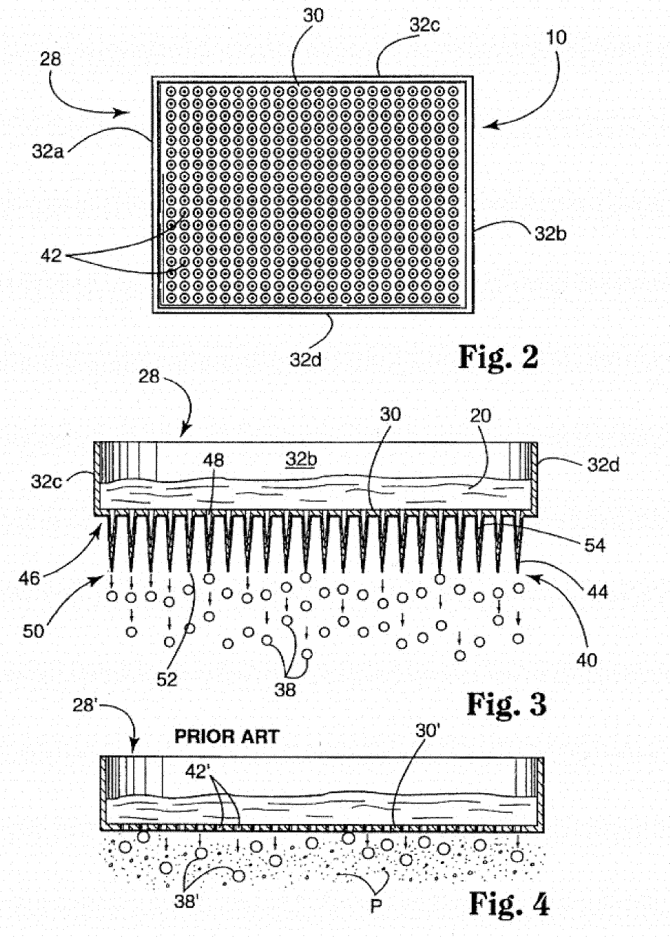

FIG. 2 depicts a tray 28 of the apparatus of FIG. 1 in accordance with the principles of the present invention.

As best shown in FIG. 2, the bottom wall 30 of the tray 28 is formed with a plurality of orifices 42, apertures 34, and/or droppers (explained below). The orifices 42 may be in an ordered array of rows and columns. It is thus perceived that the liquid composition 20 flows into and through the orifices 42 in the direction of the freezing chamber 12 during the production process.

In a key aspect of the invention, the dropper assembly 10 is formed with projections 44 that are associated with the tray 28 (see FIG. 3). More particularly, embodiments of the invention may be designed with a separate projection 44 cooperating with each individual orifice 42 formed in the bottom wall 30 of the tray 28. The projections 44 may extend downwardly from the bottom wall 30 of the tray 28 toward the freezing chamber 12. Each projection 44 thus has, at its first end 46, an inlet opening 48 that is in communication with the associated orifice 42 and, at its second end 50, an outlet opening 52.

A flow channel 54 extends the entire length of each projection 44 from the inlet opening 48 to the outlet opening 52. The projections 44 may taper to become narrower toward its second end 50. It follows then that the inlet opening 48 has a larger dimension than the outlet opening 52. The narrowing of the flow channel 54 promotes regulated accumulation of the liquid composition 20 and thus promotes regulated discharge of the liquid composition from the tray 28. The design further allows a droplet 38 to be formed in orderly fashion until the net gravity force overcomes the interfacial tension forces on the droplet and it falls toward the freezing chamber 12.

The flow rate of the liquid composition 20 through the flow channel 54 may be a factor in the orderly formation of droplets 38 at the second end 50 of the projection 44. The flow rate is a function of, among other things, the dimensions of the inlet opening 48 and the outlet opening 52. It has been determined that uniformly sized droplets 38 form and are released from the projection 44 when the ratio of the dimension of the inlet opening 48 to the outlet opening 52 is in the range of substantially 2:1 to substantially 20:1. In embodiments of the invention, the inlet opening 48 has a diameter of substantially 0.375 inches and the outlet opening 52 has a diameter of substantially 0.03125 inches. Thus, the dimension ratio may be substantially 12:1.

The tray 28 and projections 44 may be made of durable food grade plastic or stainless steel and may be formed together during original manufacture. Alternatively, the projections 44 may be later connected to the tray 28 at associated orifices 42. Pipette tips may be used as the projections 44 integrated with the tray 28 in this instance. The pipette tips of the plastic type may be purchased from instrument distributors such as Cole-Parmer@ Instrument Company of Chicago, Ill.

The principal advantages of the inventive dropper assembly 10 are best recognized by comparison with the prior art, an enlarged illustration of which is presented in FIG. 4. Using the prime identifier as a superscript for components similar to those used in the inventive assembly 10, prior art apparatus may have a tray 28′ in which orifices 42′ are formed in the bottom surface 30′. Droplets 38′ are formed and released directly from the orifices 42′ under the force of gravity. There is no opportunity for regulated accumulation of liquid composition 20′ and thus spattering frequently occurs upon release of a droplet 38′ from the orifice 42′ of the tray 28′. Furthermore, some droplets 38′ released from the orifices 42′ are so unstable that they break apart into smaller droplets, creating droplets of widely varying sizes and also resulting in further spattering.

The very small beads distract from the unique and pleasing appearance of the desirably sized beads and thus it is necessary to eliminate them from the final product. This has been accomplished in prior art designs with the use of a sieve in combination with a shaker that has been associated with the collecting pan (see '156 patent).

Furthermore, the spattering created during droplet release and/or break-up generates minute particles P that also fall into the freezing chamber and form particles of frozen microbeads that accumulate at the bottom thereof. This creates the need to shut the production process down to clean out the freezing chamber. Furthermore, the frozen microbeads represent waste, which may decrease efficient operation and production.

Numerous benefits result from the use of the inventive dropper assembly 10 and the method of feeding liquid composition to a freezing chamber using the assembly. In contrast to prior art designs, the projections 44 of the present invention promote the regulated discharge of the liquid composition from the tray 28 and the formation of uniformly sized droplets 38 of liquid composition 20 that, when delivered to the freezing chamber 12, form uniformly sized beads 18 of frozen product. The use of the novel dropper assembly 10 eliminates the need for the filtering requirement, and thus the sieve/shaker components and the power utilized to operate the shaker may be eliminated. In addition, the projections 44 prevent the spattering of minute particles of liquid composition 20 and thus prevents the formation of frozen dust that has previously accumulated at the bottom of the freezing chamber 12.

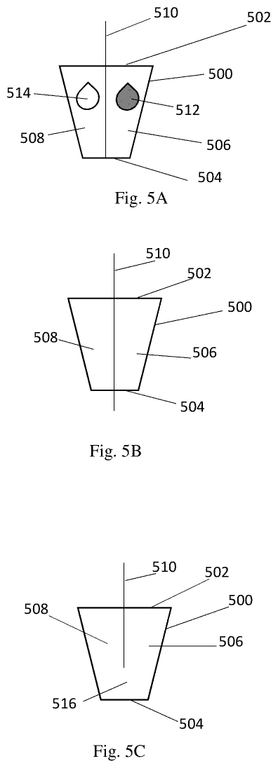

FIG. 5A depicts a dropper 500 of the tray 28 of FIG. 2 comprising a dropper divider 510 for retaining multiple discrete supplementary liquids separate before dripping in accordance with the principles of the present invention. In some embodiments, the dropper 500 may be substantially similar to the projections 44 with the addition of the dropper divider 510. The dropper 500 may comprise a lengthwise body having a first end 502 opposite a second end 504. The first end 502 may be configured to receive a supplementary liquid, such as an alimentary liquid. The second end 504 may be configured such that the received supplementary liquid may from droplets as the supplementary liquid may drip through the second end 504.

Furthermore, the dropper 500 may comprise a first chamber 506 and a second chamber 508 such that the dropper 500 may receive a first supplementary liquid 512 into the first chamber 506 and a second supplementary liquid 514 in the second chamber 508. The dropper divider 510 may prevent mixing of the first supplementary liquid 512 and the second supplementary liquid 514 while in the dropper 500. However, a flow rate of the first supplementary liquid 512 may be correlated to a flow rate of the second supplementary liquid 514 such that a droplet formed at the second end 504 may comprise the first supplementary liquid 512 and the second supplementary liquid 514. Such a droplet may be referred to as a combined droplet. The combined droplet may be dripped into a cryogenic fluid, such as liquid nitrogen, to form a combined bead. In some embodiments, the dropper divider 510 may extend beyond the first end 502 and may extend to the second end 504. In some embodiments, the combined beads may comprise multiple sections, each corresponding to the attributes of the corresponding supplementary liquid.

For example, a combined bead could comprise a strawberry flavor in the first section and a banana flavor in a second section. Furthermore, the combined bead could comprise a red color in the first section and a yellow color in the second section. Additional embodiments may include a chocolate flavor in the first section and a vanilla flavor in the second section. The combined bead could comprise a brown color in the first section and a white color in the second section. In some embodiments, these discrete sections may be distinct with minimal mixing, depending on the height of the dropper 500 from the cryogenic fluid. Furthermore, the length and shape of the dropper divider 510 beyond the second end 504 may affect the amount of mixing between the first supplementary liquid 512 and the second supplementary liquid 514 before freezing. A longer dropper divider 510 may prolong separation and may maintain independence of each section. A shorter dropper divider 510 may allow more mixing before freezing. Furthermore, the dropper divider 510 may be spiraled or otherwise shaped to induce a corresponding spiral or other corresponding shape in the resulting frozen beads.

In embodiments, a stream may be formed from the combination of the first supplementary liquid 512 and the second supplementary liquid 514 and the frozen product may be comminuted into beads or shards.

FIG. 5B depicts the dropper 500 of the tray 28 of FIG. 2 comprising an alternative arrangement dropper divider 510 in accordance with the principles of the present invention. In these embodiments, the dropper divider 510 may extend beyond the second end 504 of the dropper 500. Prolonged separation may occur between the first supplementary liquid 512 and the second supplementary liquid 514 which may affect any mixing pattern in the combined droplet and may further maintain distinct sections in the resulting frozen bead.

FIG. 5C depicts the dropper 500 of the tray 28 of FIG. 2 comprising an alternative arrangement dropper divider 510 in accordance with the principles of the present invention. In these embodiments, the dropper divider 510 may not necessarily extend to the second end 504. The resulting gap between the dropper divider 510 and the second end 504 may form a mixing area 516 within the dropper 500. The first supplementary liquid 512 may be allowed to mix with the second supplementary liquid 514 at the second end 504 before droplet formation. The resulting frozen bead may comprise more advanced mixing, but may retain distinguishable sections.

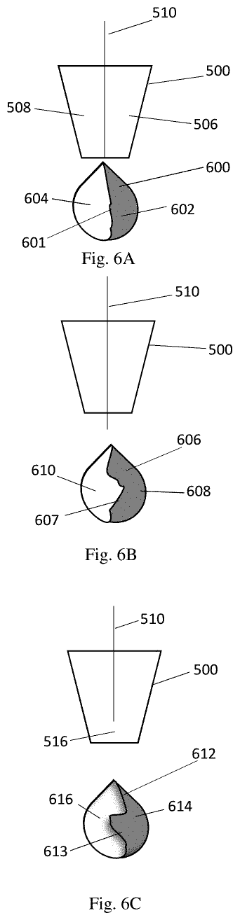

FIG. 6A depicts the dropper 500 of FIG. 5A comprising a dropper divider 510 and a combined droplet 600 comprising a first supplemental liquid section 602 and a second supplemental liquid section 604 in accordance with the principles of the present invention. In some embodiments, the first supplemental liquid section 602 may be discrete and or distinguishable from the second supplemental liquid section 604. However, some mixing or intermingling may occur before the combined droplet 600 reaches the cryogenic liquid. In some embodiments, a transition 601 between the first supplemental liquid section 602 and the second supplemental liquid section 604 may have slight mixing, swirling, and/or gradient between section 602 and section 604.

FIG. 6B depicts the dropper 500 of FIG. 5B comprising a dropper divider 510 and a combined droplet 606 comprising a first supplemental liquid section 602 and a second supplemental liquid section 604 in accordance with the principles of the present invention. The combined droplet 606 may comprise a first supplementary liquid section 608 and a second supplementary liquid section 610. Furthermore, the droplet 606 may comprise a transition 607 between the first supplementary liquid section 608 and the second supplementary liquid section 610. In some embodiments, transition 607 may be stark with minimal mixing between section 608 and section 610.

FIG. 6C depicts the dropper 500 of FIG. 5C comprising a dropper divider 510 and a combined droplet 612 comprising a first supplemental liquid section 614 and a second supplemental liquid section 616 in accordance with the principles of the present invention. The mixing area 516 may allow the first section 614 and the second section 616 to become somewhat mixed, swirled, and/or a gradient to form at transition 613.

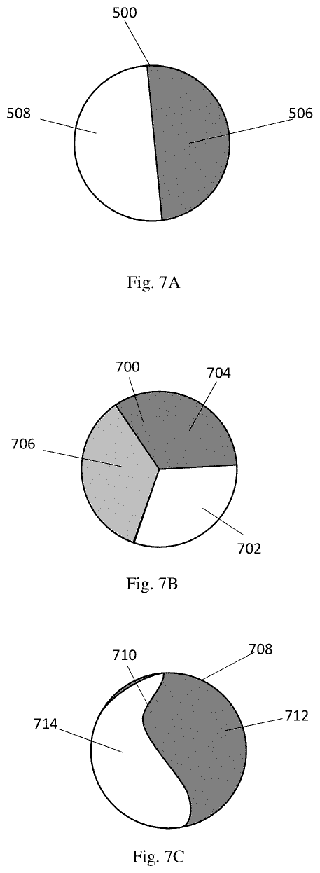

FIG. 7A depicts a view of the first end 502 of the dropper 500 of FIG. 5A in accordance with the principles of the present invention. In some embodiments, dropper 500 may comprise two or more chambers (e.g. first chamber 506 and second chamber 508).

FIG. 7B depicts a view of the first end of an alternative dropper 700 in accordance with the principles of the present invention. Some embodiments of the dropper 700 may comprise three or more chambers (e.g. first chamber 702, second chamber 704, and third chamber 706). Such embodiments may result in a combined droplet comprising a first supplementary liquid section, a second supplementary liquid section, and a third supplementary liquid section. Upon freezing, the resulting combined frozen bead may comprise three discrete and/or distinguishable sections. For example, the combined frozen bead may comprise three flavored sections each having a different flavor. The combined frozen bead may comprise three colored sections each having a different color.

FIG. 7C depicts another alternative dropper 708 comprising a spiral dropper divider 710 in accordance with the principles of the present invention. In these embodiments, the dropper 708 may promote spiraling of the first supplementary liquid 512 and the second supplementary liquid 514. The resulting combined droplet may comprise a spiraled pattern. Upon freezing, the resulting frozen bead may comprise a spiraled pattern.

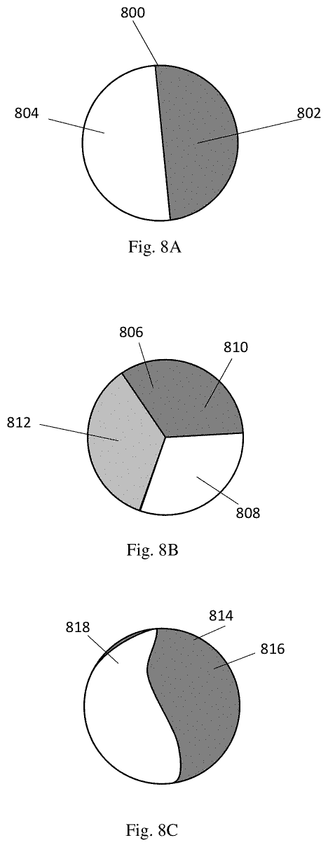

FIG. 8A depicts a frozen supplementary bead 800 comprising independent sections in accordance with the principles of the present invention. By way of example, the frozen supplementary bead 800 may comprise a first section 802 and a second section 804. The sections 802 and 804 may be distinguishable and/or discrete. For example, the first section 802 may comprise one or more attributes (such as flavor, color, microbial or other culture, and/or a pharmaceutical, such as a drug) and the second section 804 may comprise one or more attributes. Each attribute may comprise a value. For example, flavor may comprise the value “strawberry.” Additionally, the attribute color may comprise the value “pink.” The attribute “culture” may comprise the value “Lactobacillus.” The attribute “pharmaceutical” may comprise any pharmaceutical compound or any natural compound used for treatment as the value. Thus, the first section 802 and the second section 804 may comprise one or more of these attributes. However, the value of each attribute may be different for the first section 802 compared to the second section 804. The attribute values for each section may correspond to the respective supplementary liquid that preceded the corresponding section.

FIG. 8B depicts an alternate frozen supplementary bead 806 comprising discrete sections in accordance with the principles of the present invention. By way of example, the frozen supplementary bead 806 may comprise a first section 808, a second section 810, and a third section 812. The first section 808 may comprise a first attribute value. The second section 810 may comprise a second attribute value for the same attribute. The third section 812 may comprise a third attribute value for the same attribute. The first value may be different than the second value and the third value. The second value may be different than the first value and the third value. The third value may be different than the first value and the second value.

FIG. 8C depicts a swirled frozen supplementary bead 814 comprising swirled sections in accordance with the principles of the present invention. In these embodiments, a first section 816 may be swirled with the second section 818. The swirled frozen supplementary bead may be substantially similar to frozen bead 800 in every other way. The first section 816 may be discernable and/or discrete from the second section 818.

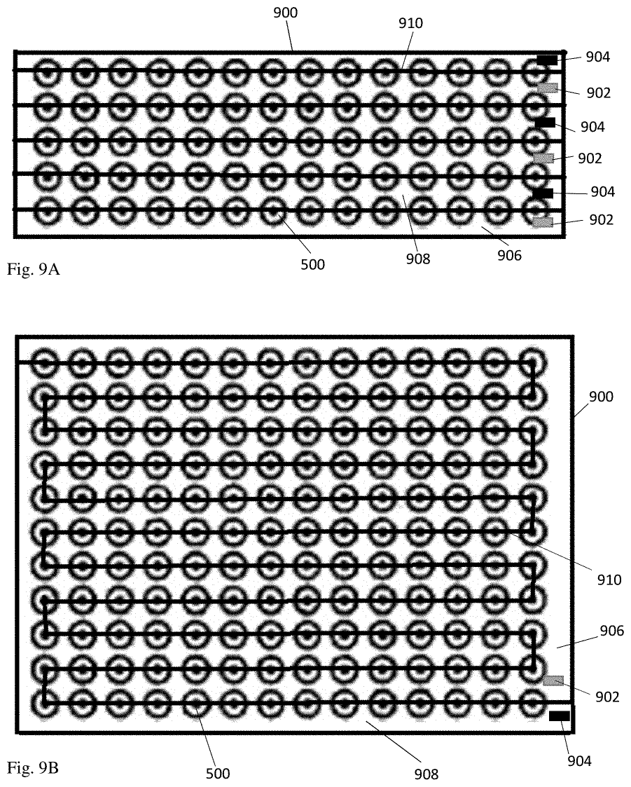

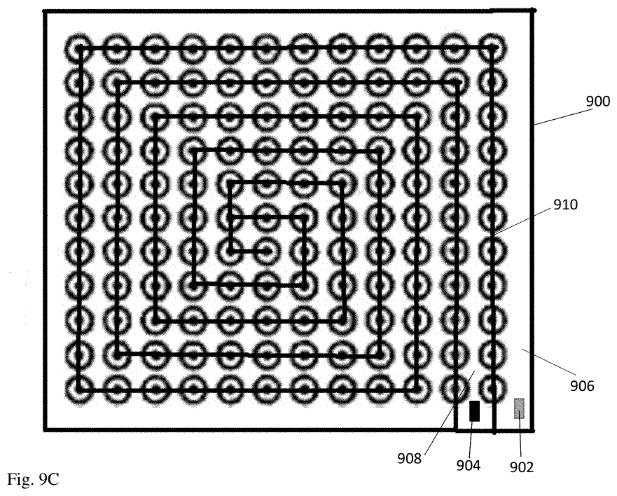

FIG. 9A depicts a top-down view of a tray 900 of the apparatus of FIG. 1 in accordance with the principles of the present invention. The tray 900 may be substantially similar to the tray 28. However, tray 900 may further comprise a tray divider 910. The tray divider 910 may be connected with one or more dropper dividers 510 of the corresponding droppers 500 under the tray divider 910. The tray dividers 910 may divide the tray 900 into two or more lanes, such as first lane 906 and second lane 908. First lane 906 may receive first supplementary liquid 512. For example, first input 902 may pour, drip, pump, or otherwise add first supplementary liquid 512 into first lane 906.

Second lane 908 may receive second supplementary liquid 514. For example, second input 904 may pour, drip, pump, or otherwise add second supplementary liquid 514 into second lane 908. The tray divider 910 may maintain separation between the first supplementary liquid 512 and the second supplementary liquid 514 in the tray 900 until the combined droplet 600, 606, 612 is dripped from dropper 500, as described above.

The first input 902 and the second input 904 may control the respective flow rates of the first supplementary liquid 512 and the second supplementary liquid 514 into the tray 900. In some embodiments, the flow rates may be matched to approximate equal portions of each of the first supplementary liquid 512 and the second supplementary liquid 514 into the combined droplets 600, 606, 612.

FIG. 9B depicts an alternative arrangement of the tray 900 of FIG. 9A in accordance with the principles of the present invention. By way of example, the tray divider 910 may comprise a serpentine pattern across droppers 500. Thus, first lane 906 and second lane 908 may comprise respective serpentine patterns. In this manner, only one first input 902 may be required to supply first lane 906. However, additional first inputs 902 may be added for quality control of flow rate across the tray 900. In some embodiments, only one second input 904 may be required to supply second lane 908. However, additional second inputs 902 may be added for quality control of flow rate across the tray 900.

FIG. 9C depicts another alternative arrangement of the tray 900 of FIG. 9A in accordance with the principles of the present invention.

The beads 800, 806, and 814 may not necessarily comprise layers and/or coatings. In some embodiments, one or more sections (e.g. first section 802 and second section 804) of the beads 800, 806, 814 may be uniform from the outer surface of the bead 800, 806, 814 to the interior of the corresponding section. In some embodiments, at least part of each of the one or more sections may be uniform from the outer surface of the bead 800, 806, 814 (e.g. without an encapsulating covering) to the interior of the corresponding section and/or to the center of the bead 800, 806, 814. Thus, the one or more sections may be side by side rather than layered. Embodiments of the present invention may not necessarily comprise a polymer, lipid, edible film, or other edible coating layer. In some embodiments, a surface of a single bead 800, 806, 814 may comprise two or more sections (e.g. first section 802 and second section 804).

In some embodiments, the first section 802 may be uniform. Alternatively, one or more attribute values of the first section 802 may be uniform across the first section 802. In some embodiments, the second section 804 may be uniform. Alternatively, one or more attribute values of the second section 804 may be uniform across the second section 804.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

What is claimed is:

1. A frozen supplementary bead, comprising:
a first section comprising an attribute comprising a first value; and
a second section comprising the attribute comprising a second value,
wherein the first value is not the second value.

2. The frozen supplementary bead of claim 1,
wherein the attribute comprises color,
wherein the first value comprises a first color, and
wherein the second value comprises a second color.

3. The frozen supplementary bead of claim 1, wherein the color of the first section is not the color of the second section.

4. The frozen supplementary bead of claim 1,
wherein the attribute comprises flavor,
wherein the first value comprises a first flavor, and
wherein the second value comprises a second flavor.

5. The frozen supplementary bead of claim 1, wherein the flavor of the first section is not the flavor of the second section.

6. The frozen supplementary bead of claim 1,
wherein the attribute comprises a culture,
wherein the first value comprises a first culture, and
wherein the second value does not comprise the first culture.

7. The frozen supplementary bead of claim 1,
wherein the attribute comprises a pharmaceutical,
wherein the first value comprises a first pharmaceutical, and
wherein the second value does not comprise the first pharmaceutical.

8. The frozen supplementary bead of claim 1, further comprising:
a third section comprising the attribute comprising a third value;
wherein the third value is not the first value, and
wherein the third value is not the second value.

9. The frozen supplementary bead of claim 1, further comprising a swirled arrangement of the first section and the second section.

10. The frozen supplementary bead of claim 1, further comprising:
a surface,
wherein the surface comprises the first section and the second section.

11. A dropper apparatus, comprising:
a dropper comprising a first chamber and a second chamber separated by a dropper divider at a first end of the dropper, the first end configured to receive a first supplementary liquid into the first chamber and a second supplementary liquid into the second chamber,
the dropper comprising a second end configured to join the first supplementary liquid and the second supplementary liquid upon dripping the first supplementary liquid and the second supplementary liquid from the dropper.

12. The dropper apparatus of claim 11, wherein the dropper divider is substantially even with the second end of the dropper.

13. The dropper apparatus of claim 11, wherein the dropper divider is beyond the second end of the dropper.

14. The dropper apparatus of claim 11, wherein the second end of the dropper is beyond the dropper divider.

15. The dropper apparatus of claim 11, further comprising:
a tray comprising a tray divider, the tray divider positioned beyond the first end of the dropper and connected with the dropper divider to prevent mixing of the first supplementary liquid and the second supplementary liquid before dripping.

16. The dropper apparatus of claim 15, wherein the tray divider spans a row of droppers.

17. The dropper apparatus of claim 15, wherein the tray divider comprises a serpentine pattern across multiple droppers.

18. The dropper apparatus of claim 15, wherein the tray divider comprises a spiral pattern across multiple droppers.

19. A method of producing a frozen supplementary bead, comprising:
dripping a first supplementary liquid and a second supplementary liquid such that the first supplementary liquid joins the second supplementary liquid in a combined droplet before reaching a cryogenic fluid,
wherein the combined droplet forms a frozen supplementary bead comprising a first section corresponding to the first supplementary liquid and a second section corresponding to the second supplementary liquid after reaching the cryogenic fluid.

20. The method of claim 19,
wherein the first section comprises a first attribute comprising a first value,
wherein the second section comprises the first attribute comprising a second value, and
wherein the first value is not the second value.
